(19) United States
(12) Patent Application Publication
(10) Pub. No.: US 2007/0297275 A1
(43) Pub. Date: Dec. 27, 2007

(54) Manual Mixing Device

(75) Inventor: Monty W. Hardman, Magna, UT (US)

Correspondence Address: MADSON & AUSTIN, 15 WEST SOUTH TEMPLE, SUITE 900, SALT LAKE CITY, UT, 84101, US

(73) Assignee: Systems of Innovation, Inc., Magna, UT (US)

(21) Appl. No.: 11/426,173

(22) Filed: Jun. 23, 2006

(51) Int. Cl. B01F 13/00

(52) U.S. Cl. 366/130

(57) ABSTRACT

A manual mixing device is disclosed. This device may be used to mix a first substance (e.g., a fluid) with a second substance (e.g., a dry mix) to produce, for example, properly mixed concrete in a moldable, or plastic, state in a very short period of time. This manual mixing device is inexpensive and is easy to use. The manual mixing device includes a base made of a flexible material. This flexible material may be made of plastic, such as Visqueen. The base receives the first substance and the second substance. At least four grips are positioned on generally opposite peripheral regions of the base. Using the manual mixing device the first and second substances may be intermingled by alternatively elevating each of the grips relative to an opposing grip to move, or fold over, the combination of the first and second substances toward the opposing grip. Once the product (e.g., moldable or wet concrete) has been properly mixed, the manual mixing device may be utilized to transport the product to a particular location. Thereafter, the product may be poured directly onto a desired location from the manual mixing device.

### BACKGROUND OF THE INVENTION

Concrete is a common building material that is used throughout the world. Not only is this material used in large building projects, but concrete is also used on smaller projects, such as a base for fence posts or a shed.

Concrete is generally formed from dry concrete mixture, which may be comprised of a mixture of dry cement powder (which may include calcium oxide), sand, and gravel. A person desiring to make concrete may purchase these ingredients as separate components and mix the ingredients to form dry concrete mixture. However, products have been introduced that contain a premixed dry concrete mixture. One example of commercially available “premixed” bags of sand, cement powder, and gravel are sold under the trademark “Quikrete®” sold by Quikrete International, Inc., of Atlanta, Ga.

Once these dry materials have been obtained and mixed in proper proportions, water may be added to the dry composition. The water must be mixed thoroughly with the dry concrete mixture to form concrete in a moldable or plastic state. The moldable concrete may then be placed within a confined area by the user and optionally shaped or smoothed to achieve a desired texture or shape. The moldable concrete is then permitted to hydrate, or cure, to form hardened concrete.

One of the difficulties associated with working with concrete is ensuring that the water has been thoroughly mixed with the dry concrete mixture. For smaller jobs, this mixing process may involve, for example, placing the dry ingredients in a wheelbarrow, adding water, and then using a shovel (or other implement) to evenly distribute the water throughout the dry mixture. This mixing process can be tiring and time consuming and is often ineffective at properly distributing the water throughout the mixture.

Furthermore, following mixing, the user may need to transport the wet or moldable concrete to a location where a wheelbarrow or other mixing container does not fit. For example, a homeowner repairing damaged concrete in the basement of his house may be required to mix the concrete outside the home in a wheelbarrow and then place the moldable concrete in buckets and transport it to the location within his basement where the moldable concrete is needed. Obviously, this process is tedious and extremely labor-intensive.

In addition, mixing concrete using a wheelbarrow, shovel, etc. can be messy, potentially spilling moldable concrete or dry ingredients onto adjacent grass or cured concrete. Also, it may be difficult to clean up the wheelbarrow and stirring implement, even if the cleaning process commences immediately after the moldable concrete has been positioned in a desired location.

Accordingly, in order to make the concrete-mixing process easier, many types of mechanical mixing devices have been constructed. For large projects, “cement trucks” have been developed that contain a large bin that rotates and mixes the concrete. A small, mechanized rotating bin with a stationary or wheeled stand may also be utilized to mix smaller amounts of concrete. Unfortunately, obtaining a concrete manual mixing device and/or ordering concrete from a “cement truck” is often not cost-effective for small projects or individuals with limited budgets. As a result, many users resort to the “old-fashioned” method of mixing concrete using a shovel and a wheelbarrow.

Accordingly, there is a need in the industry for a new type of manual mixing device that is inexpensive and that may be used to quickly mix concrete, or other substances, in small quantities. It would also be beneficial if such a device could be easily cleaned and transported, even when the mixed product is positioned therein. Such a device is disclosed and claimed herein.

### BRIEF SUMMARY OF THE INVENTION

The disclosed invention comprises a compact, manually operated mixing device for intermingling two or more substances. This device may be used to mix, for example, a first and a second substance. The first substance, in such an embodiment, may comprise a fluid, such as water, and the second substance may be a dry concrete mixture, including cement powder, sand, and gravel. Utilizing these ingredients and the disclosed device, moldable cement having water evenly distributed throughout can be formed in an extremely short period of time.

The manual mixing device comprises a base made of a flexible material. The “flexibility” of this material allows the base to be manually manipulated by a user. This flexible material may be made from various substances, such as a polymer-based material (e.g., Visqueen) or a cloth-based material such as a vinyl coated (or vinyl laminated) fabric or material. The base is designed to receive a quantity of the first substance (e.g., the fluid) and a quantity of the second substance (e.g., the dry mix) so that these substances may be intermingled. In one embodiment, the base is octagonal in shape.

The manual mixing device will also comprise one or more grips that enable a user to grasp and manipulate the device. In some embodiments, the grips may simply be a portion of the base (such as a reinforced peripheral region) that optionally includes an opening for receiving a user's hand or fingers. In other embodiments, the grips comprise handles that are affixed to a peripheral region of the base or an enlarged region of the base utilizing, for example, a dowel or multiple folds of the material from which the base is made.

In one embodiment, the manual mixing device includes an octagonal base and four grips. A grip is positioned on every other side, or alternating sides, of the base, such that an “open” octagonal side is positioned between each octagonal side having a grip. Accordingly, a first and a third grip are positioned on opposing sides of the base, and a second and a fourth base are also positioned on opposing sides of the base.

One or more pouring aprons may optionally be added to the manual mixing device. The pouring aprons comprise an area or peripheral region of the base through which the two substances (once they have been mixed) may be easily poured out of the base into a desired space or region. The pouring aprons may be situated between two adjacent grips. The pouring aprons may be recessed relative to surrounding areas of the base such that the mixed substance may be poured through the aprons without overflowing the mixed product on to the grips.

The base may also include a mixing area that is, in one embodiment, proximate to the center of the base. The mixing area may be highlighted, such as with a distinctive color or a different type of material, or may be a reinforced area of the base. The mixing area may be highlighted, whether or not this region is reinforced, to identify to the user the proper location for mixing the substances. Reinforcement of the mixing area tends to prolong the life of the base, as significant wear and tear could be imposed on this area during the mixing process.

Once the user has placed the first and second substances on the base, the user may then mix or intermingle the substances. Mixing may occur by alternatively elevating each of the grips relative to an opposing grip (i.e., a grip positioned on an opposing peripheral region of the base). This process may involve two people. For example, in one embodiment where the base includes four grips, a first user may grasp two adjacent grips while a second user grasps the remaining two grips. The first user may raise, or elevate, one of the grips relative to an opposing, thereby causing the first and second substances to move toward the opposing grip. Elevating the grip thus moves the substances on the base, causing these substances to mix or to fold over unto themselves. The second user may then elevate another one of the grips relative to an opposing grip, thereby causing the substances to further mix. This process may be repeated, as necessary, with respect to each of the grips.

After performing one or more iterations of the mixing process, the users may examine the substances and determine that an additional quantity of one of the substances is needed to achieve a desired consistency or mixture proportion. For example, after conducting the mixing process, the user may determine that an additional quantity of the first substance (the fluid) may be needed in order to fully hydrate the mixture to create moldable concrete. Accordingly, the user may add an additional quantity of fluid, and then resume the mixing process. Of course, this process may then be repeated as necessary until the desired end product (e.g., moldable concrete or masonry grout) is obtained.

Once the substances have been satisfactorily combined, the mixed product may then be poured out of the manual mixing device into the area or receptacle. This pouring may occur via one or more of the pouring aprons. Thereafter, the user can then smooth, texture, or manipulate the concrete (or other mixed product) as desired.

### BRIEF DESCRIPTION OF THE DRAWINGS

In order that the manner in which the above-recited and other features and advantages of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a plan view of one embodiment of a manual mixing device;

FIG. 2 is a perspective view of one embodiment of a handle that may be used as part of the manual mixing device;

FIG. 3 is a perspective view of one embodiment of a manual mixing device including a first and a second substance to be mixed;

FIG. 3A is a cross-sectional view that shows the substances added to the manual mixing device;

FIG. 4 is a perspective view of the manual mixing device illustrating one embodiment of a method of using the device; and

FIG. 5 shows one embodiment of the method for utilizing a manual mixing device to pour the mixed product out of the device.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in the Figures, is not intended to limit the scope of the invention, as claimed, but is merely representative of presently preferred embodiments of the invention.

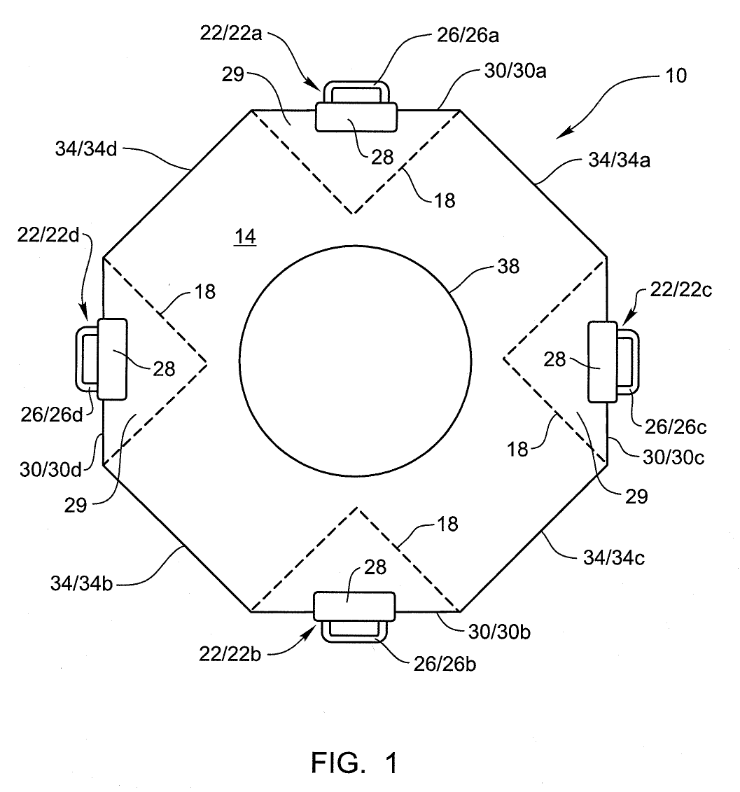

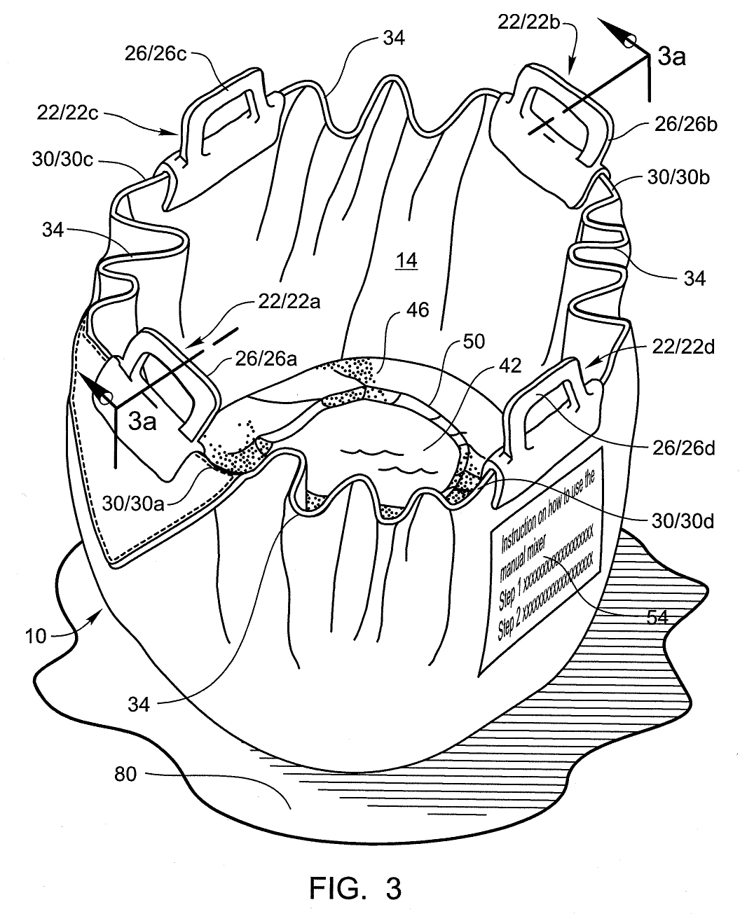

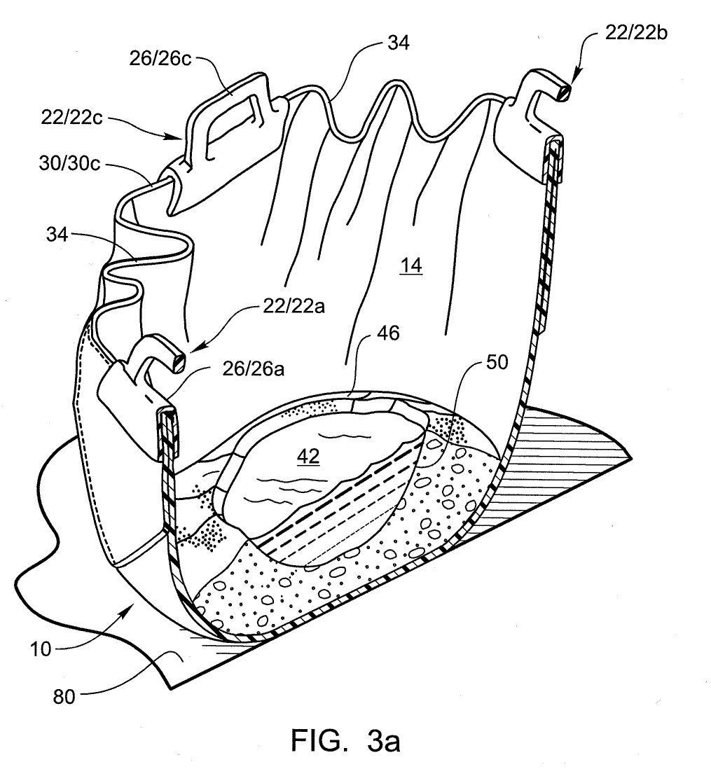

Referring now to FIG. 1, an embodiment of a manual mixing device 10 is illustrated. The illustrated manual mixing device 10 may be used to mix a first substance (shown in FIG. 3) with the second substance (shown in FIG. 3). In certain embodiments, the first substance is a fluid, such as water, and the second substance is a dry mix, such as a dry concrete mix. A dry concrete mix may comprise cement powder, sand, and gravel, which when combined with water may form moldable or wet concrete. The dry concrete mix may further comprise aggregate material(s), “filler” materials, rocks, “admix”, and/or other materials to change/modify the properties of the concrete. Ingredients for a dry concrete mix may be combined by a user or may be purchased in pre-mixed configurations.

The manual mixing device 10 is versatile and may be utilized to mix substances of many different types, not merely to form concrete. For example, the manual mixing device 10 may be used to form masonry or tile grout utilizing appropriate dry mixes. Thus, the term dry mix is broad and encompasses any substance or combination of substances that may be combined or mixed together.

The manual mixing device 10 may also be designed for use in situations in which neither the first substance nor the second substance comprises a fluid. For example, the first substance may comprise a quantity of mulch, fertilizer, or manure, and the second substance may be a quantity of top soil. The mixing of these two substances may also be accomplished by embodiments of the disclosed device 10.

The manual mixing device 10 includes a base 14. This base 14 is made of a flexible material so that it may be moved and/or manipulated by a user. This flexible material may be a plastic material, such as 12 millimeter Visqueen or other similar vinyl coated or vinyl laminated material. Of course, other types of Visqueen, such as 18 millimeter Visqueen, may also be used. Similarly, other types of flexible materials, such as cloth, fabric, and the like, may also be used to form the base 14. As shown in FIG. 1, the base 14 is a unitary sheet of material. However, other embodiments may be constructed in which the base 14 is made of multiple types of material that have been secured/joined to each other (via sewing, weaving, adhesives, tape, etc.).

As shown in FIG. 1, the base 14 may be substantially planar. As used herein, the term “substantially planar” means that, when laid flat on the ground, all or a majority of the base is flat and lies in generally the same geometric plane.

The base 14 receives a quantity of the first substance (e.g., the fluid) and a quantity of the second substance (e.g., the dry mix). More specifically, the base 14 is designed such that a user may place the first and second substances on the base 14 and may then mix the first and second substances together, utilizing a process which will be described below. In order to allow mixing of the substances, the base 14 may be made of a material that has a sufficient tear and tensile strength such that the base 14 will not tear during the mixing process. In many embodiments, this will involve making the base 14 out of a material that has sufficient tensile and tear strength that will hold and allow mixture of at least an eighty (80) pound bag of dry concrete mixture with a sufficient quantity of water (fluid) to form moldable concrete. In other embodiments, the material used for the base 14 will have sufficient tear and tensile strength such that two eighty (80) pound bags of dry concrete mixture (e.g., 160 pounds of dry concrete mixture) may be mixed with a sufficient quantity of water (fluid) to form moldable concrete.

In the embodiment shown in FIG. 1, the base 14 is generally octagonal in shape. This shape may be formed by taking a square piece of vinyl coated material or Visqueen plastic (for which the length of each side is 72 inches) and then folding the four corners inward to form an octagonal shape. The folded corners may then be affixed in their position by sewing along sew lines 18, shown in FIG. 1. Of course, in other embodiments, adhesives, tape (such as duct tape), weaving, welding, and/or other methods of affixing the folded corners to the main body of the base 14 may also be used.

Embodiments beyond the one shown in FIG. 1 may also be constructed in which the base 14 has a different shape and/or configuration. For example, other shapes, such as a square, rectangle, triangle, circle, hexagon, or polygon are also possible. “Irregular” shapes, including shapes with rounded sides, jagged edges, etc. are also possible. In fact, any shape/configuration that is capable of receiving the first and second substances may be used.

Likewise, the size/proportions of the base 14 may also be changed. For example, embodiments may be constructed in which the base 14 is 84 inches in length (as measured from one side to an opposite side). Still other embodiments may be made in which the base 14 is 60 inches in length or 90 inches in length (as measured from one side to an opposite side). Still other embodiments are designed such that the base 14 is simply cut out of a larger piece of material into any shape desired by the user. Of course, other shapes, sizes, and/or dimensions may also be used within the scope of this invention.

The manual mixing device 10 may also comprise at least four grips 22. As shown in the embodiment of FIG. 1, each single grip 22 is positioned on alternating sides of the octagonal-shaped base. Each of the grips 22 is positioned on the base generally opposite another grip 22. As illustrated, a first grip 22a is positioned generally opposite a second grip 22b and a third grip 22c is positioned generally opposite a fourth grip 22d.

As used herein, the term “grips” means any feature or structure that a user may use to grip or hold the base 14. In some embodiments, the grips 22 may simply be a portion of the base 14 (such as a peripheral region 29) that the user may utilize to grab or hold the base 14. In other embodiments, including the embodiment shown in FIG. 1, the grips 22 comprise handles 26 that are added to peripheral regions 29 of the base 14. In other embodiments, the grips 22 will comprise a surface of the base 14 that is designed to receive a handle 26. Still further embodiments may be constructed in which at least one of the grips 22 is a handle and at least one of the other grips is simply a portion of the base 14.

As noted above, each of the grips 22 of FIG. 1 comprise handles 26. As shown, a first handle 26a is positioned along a first side 30a of the octagonal-shaped base 14, a second handle 26b is positioned along a second side 30b of the octagonal-shaped base 14, a third handle 26c is positioned along a third side 30c of the octagonal-shaped base 14, and a fourth handle 26d is positioned along a fourth side 30c of the octagonal-shaped base 14. The first side 26a is generally opposite the second side 26b. Likewise, the third side 30c is generally opposite the fourth side 30d.

In the embodiment shown in FIG. 1, the handle 26 may also comprise clamping portions 28 that are designed to clamp around a peripheral region 29 of the base 14 to secure the handle to the base 14 without ripping or tearing the base 14. A hinge may also be added to the handle 26 to allow the clamping portions 28 to rotate relative to the base 14.

Referring still to FIG. 1, a mixing area 38 is also added to the base 14. This mixing area 38 is an area proximate the center of the base 14 that is designed to receive the first and second substances. In some embodiments, this mixing area 38 is an area of base 14 that has been highlighted or marked so that the user knows where to place the substances to be mixed. In other embodiments, the mixing area 38 may be reinforced or strengthened so that the first and second substances may be mixed within this area of the base 14 without tearing and/or ripping the base 14. The mixing area 38 may be formed by attaching an extra layer of flexible material to this area of the base 14 (via, for example, sewing, welding, weaving, adhesives, or tape). In other embodiments, the mixing area 38 may be reinforced by using a flexible material that is stronger (such as 18 millimeter Visqueen).

The manual mixing device 10 may optionally include one or more pouring aprons 34. The pouring aprons 34 are generally positioned between the grips 22 and constitute an area of the base 14 through which the mixed product may be poured out of the base 14. Optionally, the aprons 34 may comprise a recessed area relative to adjacent areas of the base 14. In other embodiments, the pouring aprons 34 may be additional features, such as spouts, tubes, or channels, that are added to the base 14 to facilitate the pouring of the mixed substances (moldable concrete) out of the base 14 without requiring the user to shovel or scoop the concrete out of the manual mixing device 10.

In the embodiment shown in FIG. 1, there are four pouring aprons 34 which are positioned between the grips 22. As illustrated, a first apron 34a is positioned between the first handle 26a and the third handle 26c. A second apron 34b is positioned between the second handle 26b and the fourth handle 26d, a third apron 34c is positioned between the second handle 26b and third handle 26c, and a fourth apron 34d is positioned between the first handle 26a and the fourth handle 26d.

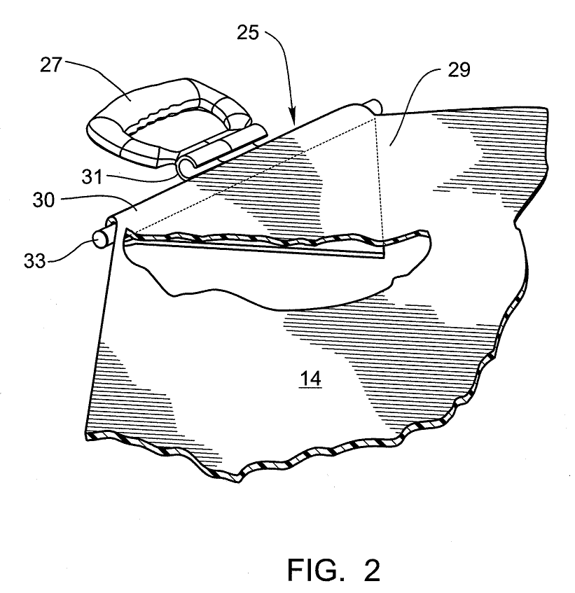

Referring now to FIG. 2, an alternative embodiment of a handle 25 is shown, which is distinguishable from the embodiment of the handle 26 shown in FIG. 1. Specifically, in FIG. 2, the handle 25 comprises a gripping portion 27 that receives the user's hand. The handle 25 also comprises an engaging portion 31 that is designed to grip and/or engage a rod 33 that has been secured to the peripheral region 29 via sewing or the like.

Both the handle 25 shown in FIG. 2 and the handle 26 shown in FIG. 1 may be made of a plastic material (such as a thermoplastic or a molded plastic) and may be attached to the base 14 via bonding, adhesives, welding, etc. Other materials may also be used to make the handles. Likewise, in some embodiments, the handles 25, 26 may be approximately 6 inches in length.

The handles 25, 26 are examples of the type of handle that may be used. In other embodiments, a handle may be a disposable or removable handle that may be clamped to the base 14. Hinged handles may also be used. In further embodiments, the handle may be integral with the base 14. In yet other embodiments, the handles may be made of the same material that is used to form the base 14. Still further embodiments are designed in which the handles are loops of fabric (or other similar materials) that are bonded or otherwise secured to the base 10.

The handle may be shaped in various ways. For example, the handles may be motorcycle type handles and/or may be made from a 5-inch electrical conduit material optionally surrounded by a rubber hose. Other handles may have connectors that operate to connect the handle to the base 14. Handles of any material, shape, or configuration that allow the user to adequately grip and secure the base 14 may be used within the scope of this invention.

Referring now to FIG. 3, a perspective view of the manual mixing device 10 is shown. The first substance 42 and the second substance 46 are also shown within the device 10. Preferably, the substances 42, 46 are positioned on the mixing area 38 (shown in FIG. 1). The sides 30 may then be pulled vertically upward to surround the substances 42, 46, as shown in FIG. 3.

As noted above, the first substance 42 is generally a fluid (such as water) whereas the second substance 46 is a dry mix (such as dry concrete mixture, etc.). Because the first substance 42 may be fluid, a user may create a cavity 50 in the pile of the second substance 46 that will hold the first substance 42 and prevent the first substance 42 from spilling. The cavity 50 is shown in greater detail in FIG. 3A, which is a cross-sectional view that illustrates the mixing device 10 that has been placed on a support surface 80 (e.g., the ground). This cavity 50 may be added, for example, by using a shovel, the user's hands, feet, or any other instrument suitable for digging. Of course, if the user chooses to use a shovel (or other similar tool), in certain embodiments, the user must be careful to ensure that the shovel blade does not rip or tear the base 14.

Referring again to FIG. 3, the manual mixing device 10 may be sized and configured to hold about 160 pounds of the second substance 46 (i.e., the dry mix) and an appropriate quantity of a fluid. Many commercially available dry mix packages (such as the “Quikrete” product noted above) are sold in 80 pound bags. Accordingly, up to two 80 pound bags of the dry mix may be placed on the manual mixing device 10 at any one time. Of course, the capacity of the manual mixing device 10 will depend on the size of the manual mixing device 10 and the tensile and tear strength of the base 14.

The amount of the first substance (fluid) that is added to the base 14 will be determined in accordance with the guidelines provided with the dry mix and the user's knowledge and experience. For example, for each 80 pound bag of concrete dry mix, it can be expected that about 1 to 1½ gallons of fluid must be added to properly form the moldable concrete. Of course, the exact amount of the fluid that is required will depend on a variety of factors that are well known to those of skill in the art including the age of the concrete mix, the variety of concrete, the amount of humidity in the air, the application for which the user desires the concrete, etc. Accordingly, those skilled in the art will clearly be able to determine how much of the first substance 42 and the second substance 46 should be added to form the proper mixture.

Referring still to FIG. 3, an additional feature of the manual mixing device 10 is illustrated. Specifically, the manual mixing device 10 may additionally comprise a set of instructions 54 which will generally inform how to properly use the manual mixing device 10. The term “generally inform” means that an explanation is given to the user of how he or she should use the device 10. It does not matter what particular words are used in this description; rather “generally inform” simply means that the user is placed in possession of the information that will allow the user to use the mixing device 10, irrespective of the specific verbiage used. As a non-limiting example, the first step in the instructions 54 may explain how and where to place the first and second substances 42, 46 on the manual mixing device 10. As noted above, this may involve explaining how and where to form a cavity 50 in the dry mix and how much of the fluid should be added. The next step(s) on the instructions may involve explaining how to mix the substances 42, 46 using the manual mixing device 10 (which process will be described in greater detail below).

As shown in FIG. 3, the instructions may be imprinted directly on the base 14 (such as on one of the sides 30). Of course, other embodiments may be constructed in which the instructions 54 are printed on a separate paper sold with the product. Yet further embodiments may be constructed in which the instructions 54 are printed on the packaging of the product.

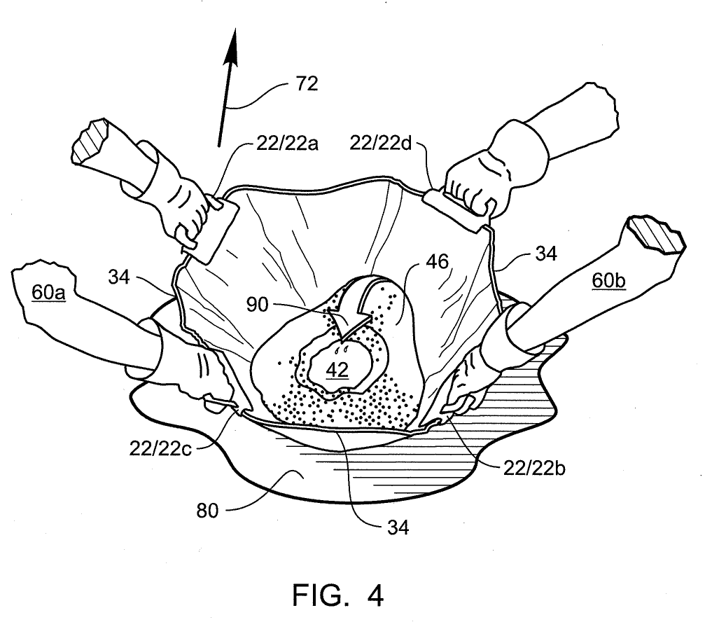

FIG. 4 illustrates one embodiment of a method of utilizing the manual mixing device 10. Once the user has placed the first and second substances 42, 46 (or a quantity of the first and second substances) on the base, the user may then mix or intermingle the substances 42, 46. The illustrated embodiment of the manual mixing device 10 is designed so that two people (i.e., a first user 60a and a second user 60b) may work together and mix the substances 42, 46. (In FIG. 4, only the arms and hands of the users 60a, 60b are shown for clarity.) The first user 60a may grasp two adjacent grips 22 and the second user 60b may grasp the two remaining grips 22. The users will then elevate the sides 30 so that the substances 42, 46 remained positioned on the mixing area 38.

In some embodiments, the manual mixing device 10 is sized so that when the sides 30 are pulled upwards, the users may secure the grips 22 standing in an upright position, while all or much of the weight of the substances 42, 46 is borne by a supporting surface (e.g., the ground) underneath the base 14. Such embodiments will allow the user to elevate one or more of the grips 22 using his/her arms and shoulders, rather than the user's back, and thus minimize the risk of injury.

This mixing will generally occur via one or more manual mixing iterations. A manual mixing iteration may include having the users 60a, 60b alternatively raise one of the grips 22 relative to an opposing grip. For example, a first user 60a may grasp the first and the third grips 22a, 22c and a second user may grasp the second and the fourth grips 22b, 22d, as shown in FIG. 4. The first user 60a raises the first grip 22a above the level of the opposing grip, namely, the second grip 22b, as indicated by the arrow 72. Raising the first grip 22a also elevates the first side 30, causing readjustment of the substances 42, 46 on the interior of the manual mixing device 10. More specifically, raising of the first grip 22a will cause the substances 42, 46 to move toward the opposite, unelevated grip (the second grip 22b) and mix or intermingle.

Once the first user 60a has raised and lowered the first grip 22a, the first user 60a may then raise the third grip 22c (which is in his other hand) in a similar manner, causing the substances 42, 46 to further mix in the manner described above. Then, the second user 60b may then elevate the second and fourth grips 22b, 22d in a similar manner to further mix the substances 42, 46.

Raising each of the grips 22 in turn constitutes one complete manual mixing iteration. Of course, the exact order in which the users 60a, 60b elevate each of the four grips 22 is immaterial; rather, all that is required for a manual mixing iteration is that each of the grips 22 are elevated at least once relative to an opposing grip. Of course, partial manual mixing iterations may be used, as appropriate.

Iterations, or partial iterations, may be repeated, as necessary. In one embodiment, proper mixture of the first and second substances 42, 46 is achieved using two manual mixing iterations. However, depending on the particular quantities of the substances 42, 46, the humidity in the air, etc., additional iterations, or partial iterations, of the mixing process may be required.

After performing one or more manual mixing iterations, the users 60a, 60b may examine the substances 42, 46 and determine that an additional quantity of either the first substance 42 or the second substance 46 may be required. For example, after conducting a first mixing iteration (or any subsequent mixing iteration), the users 60a, 60b may determine, based on the user's experience and knowledge, that an additional quantity of the first substance (the fluid) may be needed in order to fully hydrate the mixture and create moldable concrete. Similarly, after completing one or more mixing iterations, the users 60, 60b may determine that an additional quantity of the second substance 46 (the dry mix) is required, this ingredient may also be added as necessary and the composition re-mixed until the desired end product (e.g., moldable concrete) is obtained.

It should be noted that in some embodiments of the manual mixing device 10, the entire manual mixing device 10 (including the substances 42, 46 contained therein), may be lifted entirely off the ground by the users 60a, 60b during the manual mixing iterations. However, other embodiments may be constructed such that during the manual mixing iterations, a significant portion (30% of more) of the weight of the substances is borne by a supporting surface 80 to minimize weight borne by operators of the manual mixing device. This feature may be advantageous because it will not require the users 60a, 60b to support the majority of the weight of the substances 42, 46 during the mixing iterations. Thus the manual mixing device 10 is easy to use and require minimal strength and physical exertion to properly and thoroughly mix the substances.

As is readily apparent, the manual mixing device 10 of the present embodiments provides advantages over other previously known mechanisms for mixing concrete (and substances). In fact, it has been found that using a manual mixing device 10 of the present embodiments, skilled artisans can mix an 80 pound bag of “Quikcrete®” with only two manual mixing iterations. The users add about 1-1.5 gallons of water to the dry mix and perform a single manual mixing iteration. After finishing this iteration, the users determine if more water is required and add, if necessary, an additional quantity of water. Once this second amount of water is added, a second manual mixing iteration is performed. In many situations, the moldable concrete is properly formed and mixed upon the completion of the second manual mixing iteration.

Referring still to FIG. 4, the way in which the substances 42, 46 mix or intermingle during the manual mixing iterations will now be described in greater detail. As noted above, the manual mixing iterations comprise alternatively elevating each of the grips relative to an opposing grip sufficient to cause the substances 42, 46 to move toward the opposing grip. Thus, when the user elevates grip 22, at least a portion of the substances 42, 46 begins to move upward with the elevated side 30a for a small instant, and then, these substances will fall, under the force of gravity, back towards the center of the mixing area 38 and towards the opposing side 30b. As these substances 42, 46 move, they will be “folded” over on each other as shown by the arrow 90. In certain embodiments, it is this folding movement of the substances 42, 46 that causes the substances 42, 46 to thoroughly intermingle and mix.

One of the advantages of the manual mixing device 10 is that it may be disposable, i.e., it may be simply thrown away for easy clean-up. It is envisioned that, if the base 14 is made of 12 millimeter Visqueen or a vinyl coated fabric material, the manual mixing device 10 will wear out in about a day of use, or the equivalent of mixing about 30 batches of concrete. Of course, the exact lifespan of the manual mixing device 10 will depend on a variety of factors, such as the amount of concrete mixed and the care exercised by the users (i.e., whether the users rip the manual mixing device 10, puncture it with a shovel, etc.). Likewise, if the quantity of dry mix used contains sharp, jagged pieces of gravel or other aggregates, these rocks may tear the manual mixing device 10 and decrease its lifespan. Of course, if the manual mixing device 10 is made of a stronger material, then the lifespan of the manual mixing device 10 may be increased. For example, a stronger grade of plastic or flexible material may be used to create a “professional grade” manual mixing device 10, which could last much longer than a standard grade device 10.

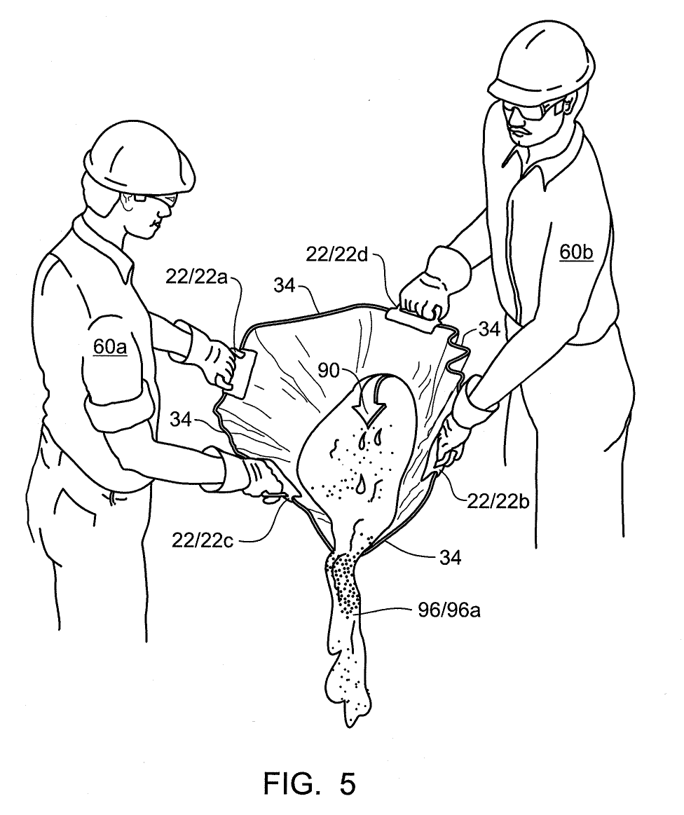

FIG. 5 shows the way in which the users 60a, 60b may conveniently move the mixed substances 42, 46 from the manual mixing device 10 to desired location. Specifically, once the users have satisfactorily mixed the substances 42, 46 (which in the case of FIG. 5 is moldable concrete 96a), the users 60a, 60b, may then pour the mixed substance 96 out of the manual mixing device 10 on to a desired location. The mixed substance 96 may be poured through one or more of the pouring aprons 34. Specifically, the users 60a, 60b will simply lift/adjust the manual mixing device 10 so that the mixed concrete (or other product) flows out of the manual mixing device 10 into the desired area. The user can then smooth or manipulate the mixed product 96, as desired. Any one of the pouring aprons 34 may be used to pour out the product. Furthermore, a portion of the mixed product 96 may be poured out of a first apron 34a while a portion of the mixed product 96 may be poured out of another apron 34b, enabling convenient placement of the mixed product 96 without the need to completely rotate the base 14. Accordingly, the users 60a, 60b may simply use the apron 34 that is closest and/or most convenient in pouring the mixed product 96.

As shown in FIGS. 1-5, those of skill in the art will recognize that the manual mixing device of the present embodiments will provide a quick method for mixing and pouring concrete using the manual mixing device 10. Accordingly, significant advantages may be had over previously known systems/products.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A manual mixing device comprising:
a substantially planar base comprising a flexible material of sufficient tensile and tear strength to receive, without tearing, at least eighty pounds of dry concrete mixture and approximately one to one and a half gallons of water to form moldable concrete when properly intermingled with the dry concrete mixture; and
at least four grips positioned on peripheral regions of the base, wherein each of the grips is positioned on the base generally opposite one of the other grips;
wherein when the dry mix and the fluid are positioned on the base, the dry mix and the fluid may be properly mixed by elevating each of the grips, at least once, relative to an opposing grip sufficient to cause the fluid and the dry mix to move toward the opposing grip.

2. The manual mixing device of claim 1, wherein each grip comprises a handle secured to the base.

3. The manual mixing device of claim 1, wherein the base has a tensile and tear strength sufficient to receive up to 160 pounds of dry concrete mixture and two to three gallons of water.

4. The manual mixing device of claim 1, wherein the base is octagonal in shape.

5. The manual mixing device of claim 1, further comprising at least one pouring apron positioned on a peripheral region of the base between two of the grips.

6. The manual mixing device of claim 1, wherein the base further comprises a mixing area.

7. The manual mixing device of claim 1, wherein when the first and second substances are being mixed together, a significant portion of a weight of the dry concrete mixture and water is borne by a supporting surface to minimize weight borne by operators of the manual mixing device.

8. The manual mixing device of claim 1, wherein elevating each grip relative to an opposing grip causes a combination of the dry concrete mixture and the water to fold over on to itself.

9. The manual mixing device of claim 1, wherein the base is disposable.

10. The manual mixing device of claim 1, wherein the dry concrete mixture and water may be properly mixed using two manual mixing iterations, each manual mixing iteration comprising elevating each of the grips relative to an opposing grip sufficient to cause the fluid and the dry mix to move toward the opposing grip.

11. A manual mixing device comprising:
a substantially planar base comprising a flexible material for receiving a first substance and a second substance, wherein the first and the second substances are capable of being mixed; and
at least four grips positioned on peripheral regions of the base, wherein each of the grips is positioned on the base generally opposite one of the other grips;
wherein when the first and second substances are positioned on the base, the first and second substances may be properly mixed by elevating each of the grips, at least once, relative to an opposing grip sufficient to cause the first and second substances to move toward the opposing grip.

12. The manual mixing device of claim 11, wherein the base is octagonal in shape and a single grip is positioned on alternating sides of the octagonal-shaped base.

13. The manual mixing device of claim 12, further comprising a mixing area positioned at a center of the octagonal-shaped base.

14. The manual mixing device of claim 13, further comprising a pouring apron positioned between two of the grips.

15. The manual mixing device of claim 11, wherein the first substance comprises water and the second substance comprises a dry concrete mixture.

16. A manual mixing device comprising:
a substantially planar base comprising a flexible material for receiving a first substance and a second substance, wherein the first and the second substances are capable of being mixed;
at least four grips positioned on peripheral regions of the base, wherein each of the grips is positioned on the base generally opposite one of the other grips; and
instructions that generally inform a user to place the first and second substances on the base and then to mix the first and second substances by elevating each of the grips, at least once, relative to an opposing grip sufficient to cause the first and second substances to move toward the opposing grip.

17. The manual mixing device of claim 16, wherein the instructions are printed on the base.

18. A method for mixing a fluid with a dry mix comprising:
obtaining a manual mixing device comprising:
substantially planar base comprising a flexible material for receiving a first substance and a second substance that are capable of being mixed together;
four grips positioned on peripheral regions of the base, wherein each of the grips is positioned on the base generally opposite one of the other grips;
placing a first quantity of the first substance and a second quantity of the second substance on the base; and
mixing the first and second substances by elevating each of the grips, at least once, relative to an opposing grip sufficient to cause the first and second substances to move toward the opposing grip.

19. The method of claim 18, wherein mixing comprises elevating each of the grips, at least once, relative to an opposing grip sufficient to cause a combination of the first and second substances to fold over on to itself.

20. The method of claim 18, when the first and second substances are being mixed together, a significant portion of a weight of the dry mix and fluid is borne by a supporting surface to minimize weight borne by operators of the manual mixing device.

21. The method of claim 18, wherein the dry mix and fluid may be properly mixed with the fluid using two manual mixing iterations, each manual mixing iteration comprising elevating each of the grips relative to an opposing grip sufficient to cause the fluid and the dry mix to move toward the opposing grip.

22. The method of claim 18, wherein the mixing is performed by two people, each person securing one of the grips with one hand and, in turn, elevating one of the grips relative to an opposing grip to mix the first and the second substances.
